(19) United States
(12) Patent Application Publication
(10) Pub. No.: US 2014/0155036 A1
(43) Pub. Date: Jun. 5, 2014

(54) METHOD, APPARATUS AND SYSTEM FOR PROCESSING INTER-PLMN ACCESS CONTROL

(71) Applicant: Huawei Technologies Co., Ltd., Shenzhen (CN)

(72) Inventors: Dong Zhao, Shenzhen (CN); Lan Zou, Shenzhen (CN)

(73) Assignee: Huawei Technologies Co., Ltd., Shenzhen (CN)

(21) Appl. No.: 14/175,083

(22) Filed: Feb. 7, 2014

Related U.S. Application Data
(63) Continuation of application No. PCT/CN2012/079829, filed on Aug. 8, 2012.

(30) Foreign Application Priority Data
Aug. 8, 2011 (CN) 201110226100.2
Aug. 12, 2011 (CN) 201110230998.0

(51) Int. Cl. H04W 12/06; H04W 74/00

(52) U.S. Cl. CPC H04W 12/06; H04W 74/002
USPC 455/411

(57) ABSTRACT

The present invention discloses a method, an apparatus and a system for processing inter-PLMN access control. The method includes: receiving access authority control information which includes an access permission relationship between PLMNs; performing corresponding access control or a function according to the access permission relationship.

### CROSS-REFERENCE TO RELATED APPLICATIONS

This application is a continuation of International Application No. PCT/CN2012/079829, filed on Aug. 8, 2012, which claims priority to Chinese Patent Application No. 201110226100.2, filed on Aug. 8, 2011 and Chinese Patent Application No. 201110230998.0, filed on Aug. 12, 2011, all of which are hereby incorporated by reference in their entireties.

### TECHNICAL FIELD

Embodiments of the present invention relate to communication technologies, and particularly, to a method, an apparatus and a system for processing inter-public land mobile network (Public Land Mobile Network, PLMN) access control.

### BACKGROUND

In prior art, each operator may own networks of different radio access technology (Radio Access Technology, RAT), and each network uses one PLMN identity. In other words, each operator may own a plurality of PLMN identities. In addition, different operators may also share a same network, namely, different operators may also own a same PLMN identity. Herein the network means an access network and/or a core network.

In the process of implementing the present invention, the inventors find that the prior art at least has the following problem: when a terminal accesses another network, namely, when the terminal accesses another PLMN, an appropriate solution needs to be considered for realizing handover and reselection by the terminal, continuity of an existing service of the terminal and the like, because one terminal can merely belong to one network.

### SUMMARY

Embodiments of the present invention provide a method, an apparatus and a system for processing inter-PLMN access control, for solving the problem that handover, reselection, continuity of an existing service of the terminal, and the like cannot be realized by a terminal or a network element in the prior art, when the terminal accesses another network, namely, when the terminal accesses another PLMN.

In one aspect, the present invention provides a method for processing inter-PLMN access control, comprising:

receiving access authority control information, wherein the information comprises an access permission relationship between PLMNs;

performing corresponding access control or a function according to the access permission relationship.

In another aspect, the present invention provides an apparatus for processing access control, comprising:

an obtaining module, configured to receive access authority control information, wherein the information comprises a access permission relationship between PLMNs;

a processing module, coupled with the obtaining module, configured to perform corresponding access control or a function according to the permission relationship.

In another aspect, the present invention provides a system, comprising the above apparatus for processing access control and a terminal communicating with the apparatus for processing access control.

In another aspect, the present invention provides an apparatus, comprising a storage component and a processor, wherein the processor is configured to read and run program instructions stored in the storage component, so that the following steps of a method are performed:

receiving access authority control information, wherein the information comprises an access permission relationship between PLMNs;

performing corresponding access control or a function according to the access permission relationship.

In the method, the apparatus and the system for processing inter-PLMN access control, the access authority control information between PLMNs is queried to check whether an access permission relationship between one PLMN and another PLMN exist, and if the access permission relationship exists, corresponding access control or a function can be performed according to the access permission relationship, thereby solving the problem that handover, reselection, continuity of an existing service of the terminal, and the like cannot be realized by the terminal or the network element in the prior art, when the terminal accesses another network, that is, when the terminal accesses another PLMN.

### BRIEF DESCRIPTION OF DRAWINGS

In order to illustrate technical solutions in embodiments of the present invention or the prior art more clearly, a brief introduction to the accompanying drawings needed in the description of the embodiments or the prior art will be given below. Apparently, the drawings described below are merely some embodiments of the present invention, and other drawings can be obtained by persons of ordinary skill in the art without any inventive efforts according to these drawings.

FIG. 1 is a schematic flowchart of a method for processing inter-PLMN access control according to an embodiment of the present invention;

FIG. 2 is a schematic flowchart of a method for processing inter-PLMN access control according to another embodiment of the present invention;

FIG. 3 is a schematic flowchart of a method for processing inter-PLMN access control according to yet another embodiment of the present invention;

FIG. 4 is a schematic flowchart of a method for processing inter-PLMN access control according to yet another embodiment of the present invention;

FIG. 5 is a schematic flowchart of a method for processing inter-PLMN access control according to yet another embodiment of the present invention;

FIG. 6 is a schematic flowchart of a method for processing inter-PLMN access control according to yet another embodiment of the present invention;

FIG. 7 is a schematic structural diagram of an apparatus for processing inter-PLMN access control according to an embodiment of the present invention.

### DESCRIPTION OF EMBODIMENTS

To make objectives, technical solutions and advantages of embodiments of the present invention clearer, a clear and complete description of technical solutions of the embodiments of the present invention will be given below, in combination with the accompanying drawings in the embodiments of the present invention. Apparently, the embodiments described below are a part, but not all, of the embodiments of the present invention. All of other embodiments, obtained by persons of ordinary skill in the art based on the embodiments of the present invention without any inventive efforts, fall into the protection scope of the present invention.

A network in the embodiments of the present invention may be one or any combination of the followings: code division multiple access (Code Division Multiple Access, CDMA), time division multiple access (Time Division Multiple Access, TDMA), frequency division multiple access (Frequency Division Multiple Access, FDMA), orthogonal frequency division multiple access (Orthogonal Frequency Division Multiple Access, OFDMA), SC-FDMA, or other networks. A wireless technology may be employed in a CDMA network, such as Universal Terrestrial Radio Access (UTRA), cdma2000 or the like. The UTRA includes Wideband CDMA (WCDMA) and other CDMA evolved networks. The cdma2000 includes IS-2000, IS-95 and IS-856 standard specifications. The IS-2000 is also referred to as CDMA IX, and the IS-856 is also referred to as Evolution-Data Optimized (EVDO). A wireless technology may be employed in a TDMA network, such as Global System for Mobile Communications (GSM), Digital Advanced Mobile Phone System (D-AMPS) or the like. A wireless technology may be employed in an OFDMA network, such as Evolved UTRA (E-UTRA), Ultra Mobile Broadband (UMB), IEEE 802.16 (WiMAX), IEEE 802.20 or the like. The UTRA and the E-UTRA are part of Universal Mobile Telecommunication System (UMTS). 3GPP Long Term Evolution (LTE) and LTE Advanced (LTE-A) are new versions of UMTS using the E-UTRA. The UTRA, the E-UTRA, the UMTS, the LTE, the LTE-A and the GSM are described in many documents of “3rd Generation Partnership Project” (3GPP) organization. The cdma2000 and the UMB are described in many documents of “3rd Generation Partnership Project 2” (3GPP2) organization. A network in the embodiments of the present invention may include a plurality of base stations, and a base station supports bidirectional communication with a wireless device in the coverage thereof.

FIG. 1 is a schematic flowchart of a method for processing inter-PLMN access control according to an embodiment of the present invention. As shown in FIG. 1, the method of the embodiment includes:

Step 102: receiving access authority control information, where the information includes an access permission relationship between PLMNs.

For example, the information may include an access permission relationship between a source PLMN and a target PLMN which correspond to a network element or a terminal.

The information may also include a PLMN list, where the list lists a group of PLMN identities, indicating:

access permission relationships between every two of a plurality of PLMNs corresponding to the group of PLMN identities respectively, wherein any two PLMNs include a source PLMN and a target PLMN; or

PLMNs corresponding to the group of PLMN identities respectively are PLMNs permitting a network element or a terminal to access.

Herein, the access permission relationship may specifically be:

whether a network element of the source PLMN is permitted to select a terminal to perform a minimization of drive-tests function after the terminal belonging to the target PLMN moves to the source PLMN; and/or

whether a minimization of drive-tests task activated by a terminal in the target PLMN is permitted to be continuously performed in the source PLMN after the terminal belonging to the target PLMN moves to the source PLMN.

In the embodiment, the access authority control information of a plurality of PLMNs is configured by a network manager system (Network Manager System, NMS) of an operator to a network element manager system (Network Element Manager System, EMS) corresponding to the NMS of the operator. The access authority control information of the plurality of PLMNs may be set to a network element managed by the EMS, after the EMS receives the access authority control information of the plurality of PLMNs. Wherein, the network element may be an access network element, including but not limited to, an evolved Node B (evolved Node B, eNB), or a radio network controller (Radio Network Controller, RNC), or a base station controller (Base Station Controller, BSC); or the network element may be a core network element, including but not limited to, a mobility management entity (Mobility Management Entity, MME) of a core network, or a general packet radio service (General Packet Radio Service, GPRS) serving GPRS support node (Serving GPRS Support Node, SGSN), or a mobile switching center (Mobile Switching Center, MSC), or a gateway GPRS support node (Gateway GPRS Support Node, GGSN).

In addition, the access authority control information of the plurality of PLMNs may also be configured to the terminal by the network element managed by the EMS. For example, the network element managed by the EMS may also send the access authority control information of the plurality of PLMNs to the terminal, and the terminal determines whether to perform a corresponding function or information access according to the control information. Where the corresponding function may include: recording cell information of a PLMN that the terminal accesses, which is measured by the terminal.

For example, in the embodiment, when a terminal moves from a source PLMN to a target PLMN, namely, when the terminal accesses another PLMN, a network element of the target PLMN queries its configured access authority control information of a plurality of PLMNs, and checks whether an access permission relationship exists between the source PLMN and the target PLMN which correspond to the terminal. Or, when a first network element of the source PLMN needs to access existing data in a second network element of the target PLMN, the second network element of the target PLMN queries its configured access authority control information of a plurality of PLMNs, and checks whether an access permission relationship exists between the source PLMN and the target PLMN which correspond to the first network element.

In addition, the access permission relationship at least includes one or any combination of the following access permission relationships: whether a network element belonging to the source PLMN is permitted to access existing data in a network element belonging to the target PLMN; whether a network element belonging to the target PLMN is permitted to access existing data in a network element belonging to the source PLMN; whether a network element belonging to the source PLMN is permitted to transmit mobility control data to a network element belonging to the target PLMN for an inter-PLMN movement of the terminal; whether a network element belonging to the target PLMN is permitted to transmit mobility control data to a network element belonging to the source PLMN for an inter-PLMN movement of the terminal; whether a terminal belonging to the source PLMN is permitted to move to the target PLMN; whether a terminal belonging to the target PLMN is permitted to move to the source PLMN; whether an existing function is permitted to be continuously performed after a terminal belonging to the source PLMN moves to the target PLMN; whether an existing function is permitted to be continuously performed after a terminal belonging to the target PLMN moves to the source PLMN; whether the target PLMN is permitted to select a specified function or application to perform after a terminal belonging to the source PLMN moves to the target PLMN; whether the source PLMN is permitted to select a specified function or application to perform after a terminal belonging to the target PLMN moves to the source PLMN; whether the target PLMN is permitted to select a specified function or application to perform when a terminal belonging to the source PLMN moves towards the target PLMN; whether the source PLMN is permitted to select a specified function or application to perform when a terminal belonging to the target PLMN moves towards the source PLMN.

It should be noted that, after the terminal belonging to the source PLMN moves to the target PLMN, whether the target PLMN is permitted to select a specified function or application to perform may be specifically realized in following two modes:

First mode: whether a network element of the target PLMN is permitted to select the terminal to perform a minimization of drive-tests (Minimization of Drive-Tests, MDT) function after the terminal belonging to the source PLMN moves to the target PLMN.

Second mode: whether an MDT task activated by the terminal in the source PLMN is permitted to be continuously performed in the target PLMN after the terminal belonging to the source PLMN moves to the target PLMN.

After the terminal belonging to the target PLMN moves to the source PLMN, whether the source PLMN is permitted to select a specified function or application to perform may be specifically realized in following two modes:

First mode: whether a network element of the source PLMN is permitted to select the terminal to perform an MDT function after the terminal belonging to the target PLMN moves to the source PLMN.

Second mode: whether an MDT task activated by the terminal in the target PLMN is permitted to be continuously performed in the source PLMN after the terminal belonging to the target PLMN moves to the source PLMN.

In another embodiment, when the terminal belonging to the source PLMN moves towards the target PLMN, whether the target PLMN is permitted to select a specified function or application to perform may specifically be: whether a minimization of drive-tests task activated by the terminal in the source PLMN is permitted to be continuously performed in the target PLMN when the terminal belonging to the source PLMN moves towards the target PLMN. In the embodiment, whether the minimization of drive-tests task activated by the terminal in the source PLMN is permitted to be continuously performed in the target PLMN may be determined by a network element or a cell of the source PLMN according to the access permission relationship. In the embodiment, if the minimization of drive-tests task activated by the terminal in the source PLMN is not permitted to be continuously performed in the target PLMN, the network element or the cell of the source PLMN may terminate the minimization of drive-tests task.

In another embodiment, when the terminal belonging to the source PLMN moves towards the target PLMN, whether the target PLMN is permitted to select a specified function or application to perform may specifically be: a core network element of the target PLMN is permitted to select the terminal to perform a minimization of drive-tests task or continue an existing minimization of drive-tests task by using an existing method for setting a minimization of drive-tests consent corresponding to the terminal.

In another embodiment, when the terminal belonging to the target PLMN moves towards the source PLMN, whether the source PLMN is permitted to select a specified function or application to perform may specifically be: whether a minimization of drive-tests task activated by the terminal in the target PLMN is permitted to be continuously performed in the source PLMN when the terminal belonging to the target PLMN moves towards the source PLMN. In the embodiment, whether the minimization of drive-tests task activated by the terminal in the target PLMN is permitted to be continuously performed in the source PLMN may be determined by a network element or a cell of the target PLMN according to the access permission relationship. In the embodiment, if the minimization of drive-tests task activated by the terminal in the target PLMN is not permitted to be continuously performed in the source PLMN, the network element or the cell of the target PLMN may terminate the minimization of drive-tests task.

Step 103: performing corresponding access control or a function according to the access permission relationship.

In the embodiment, when a network element in the target network queries its configured access authority control information of a plurality of PLMNs and finds that an access permission relationship exists between the source PLMN and the target PLMN, the corresponding access control or the function may be performed according to the access permission relationship. The access control or the function includes: handover and reselection of an inter-PLMN terminal, continuous processing of an existing service of the terminal, recording cell information of a PLMN that the terminal accesses measured by the terminal, a minimization of drive-tests function or the like.

Herein performing the corresponding access control or the function according to the access permission relationship may also mean: all PLMNs that the terminal can mobility access are permitted to perform an MDT continuing function, an MDT terminal selection function, a trace function, and a data sharing access function.

In the embodiment, whether an access permission relationship exists between a source PLMN and a target PLMN which correspond to a network element or a terminal may be checked by querying the access authority control information of a plurality of PLMNs, and if the access permission relationship exists, corresponding access control or a function may be performed according to the access permission relationship, thereby solving the problem that handover, reselection, continuity of an existing service of the terminal and the like cannot be realized by the terminal or the network element in the prior art, when the terminal accesses another network, namely, when the terminal accesses another PLMN.

Further, in another embodiment of the present invention, a source PLMN identity may be used for identifying the source PLMN, and a target PLMN identity may be used for identifying the target PLMN.

Specifically, the source PLMN corresponds to a network registered by the terminal, and the source PLMN identity is a PLMN identity corresponding to the network registered by the terminal;

or,

the source PLMN corresponds to a network which a data access party is in, and the source PLMN identity is a PLMN identity corresponding to the network which the data access party is in;

or,

the source PLMN identity is a PLMN identity corresponding to a network which a function initiator or initializer is in; and the source PLMN is the network which the function initiator or the initializer is in.

In addition, the access authority control information in the aforementioned embodiments may include one or any combination of the following access authority control information relating to a plurality of PLMNs:

First access authority control information may specifically be a table including a pair of PLMN identities, wherein the pair of PLMN identities includes a source PLMN identity and a target PLMN identity which correspond to each other.

In this scene, a specific implementation of step 103 is:

if a source PLMN identity and a target PLMN identity which correspond to each other exist, a network element of the target PLMN is permitted to select a terminal to perform a minimization drive-tests function or continue an activated minimization drive-tests function after the terminal belonging to the source PLMN moves to the target PLMN; or, a network element of the source PLMN is permitted to select a terminal to perform a minimization drive-tests function or continue an activated minimization drive-tests function after the terminal belonging to the target PLMN moves to the source PLMN;

if a source PLMN identity and a target PLMN identity which correspond to each other do not exist, the network element of the target PLMN is prohibited to select the terminal to perform the minimization drive-tests function or continue the activated minimization drive-tests function after the terminal belonging to the source PLMN moves to the target PLMN; or, the network element of the source PLMN is prohibited to select the terminal to perform the minimization drive-tests function or continue the activated minimization drive-tests function after the terminal belonging to the target PLMN moves to the source PLMN.

Second access authority control information may specifically be a table including a pair of PLMN identities and an MDT function identity, wherein the pair of PLMN identities includes a source PLMN identity and a target PLMN identity which correspond to each other.

In this scene, another specific implementation of step 103 is:

if a source PLMN identity and a target PLMN identity which correspond to each other exist, the source PLMN identity and the target PLMN identity are checked whether corresponding to an MDT function;

if both the source PLMN identity and the target PLMN identity correspond to the MDT function identity, a network element of the target PLMN is permitted to select a terminal to perform an MDT function or continue an activated MDT function after the terminal belonging to the source PLMN moves to the target PLMN; or, a network element of the source PLMN is permitted to select a terminal to perform an MDT or continue an activated MDT function after the terminal belonging to the target PLMN moves to the source PLMN;

if both the source PLMN identity and the target PLMN identity do not correspond to the MDT function identity, a network element of the target PLMN is prohibited to select a terminal to perform an MDT function or continue an activated MDT function after the terminal belonging to the source PLMN moves to the target PLMN; or, a network element of the source PLMN is prohibited to select a terminal to perform an MDT function or continue an activated MDT function after the terminal belonging to the target PLMN moves to the source PLMN.

Third access authority control information may specifically be a table including a pair of PLMN identities, an MDT function identity, a permitting identity and/or a prohibiting identity, wherein the pair of PLMN identities includes a source PLMN identity and a target PLMN identity which correspond to each other.

In this scene, yet another specific implementation of step 103 is:

if a source PLMN identity and a target PLMN identity which correspond to each other exist, an MDT function identity corresponding to the source PLMN identity and the target PLMN identity is checked whether corresponding to a permitting identity or a prohibiting identity;

if the MDT function identity corresponding to the source PLMN identity and the target PLMN identity corresponds to the permitting identity, a network element of the target PLMN is permitted to select a terminal to perform an MDT function or continue an activated MDT function after the terminal belonging to the source PLMN moves to the target PLMN; or, a network element of the source PLMN is permitted to select a terminal to perform an MDT function or continue an activated MDT function after the terminal belonging to the target PLMN moves to the source PLMN;

if the MDT function identity corresponding to the source PLMN identity and the target PLMN identity corresponds to the prohibiting identity, a network element of the target PLMN is prohibited to select a terminal to perform an MDT function or continue an activated MDT function after the terminal belonging to the source PLMN moves to the target PLMN; or, a network element of the source PLMN is prohibited to select a terminal to perform an MDT function or continue an activated MDT function after the terminal belonging to the target PLMN moves to the source PLMN.

Fourth access authority control information includes a source PLMN identity and a target PLMN identity.

In this scene, another specific implementation of step 103 is:

if a source PLMN identity and a target PLMN identity which correspond to a terminal or a network element exist, the terminal or the network element is permitted to perform corresponding access control or a function in a target PLMN corresponding to the target PLMN identity.

In addition, it should be noted that, if the source PLMN identity and the target PLMN identity which correspond to the terminal or the network element do not exist, the terminal or the network element is prohibited to perform corresponding access control or a function in a network corresponding to the target PLMN identity.

Fifth access authority control information includes a source PLMN identity, a target PLMN identity, a permitting identity and/or a prohibiting identity.

In this scene, yet another implementation of step 103 is:

if a source PLMN identity and a target PLMN identity which correspond to each other exist, the source PLMN identity and the target PLMN identity are checked whether corresponding to a permitting identity or a prohibiting identity;

if the source PLMN identity and the target PLMN identity correspond to the permitting identity, a network element or a terminal is permitted to perform corresponding access control or a function in a target PLMN corresponding to the target PLMN identity;

if the source PLMN identity and the target PLMN identity correspond to the prohibiting identity, the network element or the terminal is prohibited to perform corresponding access control or a function in the target PLMN corresponding to the target PLMN identity.

Sixth access authority control information includes a source PLMN identity, a target PLMN identity, and a terminal category or a terminal access number.

In this scene, another implementation of step 103 is:

if a source PLMN identity and a target PLMN identity which correspond to each other exist, a network element or a terminal corresponding to the terminal category or the terminal access number is permitted to perform corresponding access control or a function in a target PLMN corresponding to the target PLMN identity.

Seventh access authority control information includes a source PLMN identity, a target PLMN identity, a permitting identity and/or a prohibiting identity, and a terminal category or a terminal access number.

In this scene, yet another implementation of step 103 is:

if a source PLMN identity and a target PLMN identity which correspond to each other exist, the source PLMN identity and the target PLMN identity are checked whether corresponding to a permitting identity or a prohibiting identity;

if the source PLMN identity and the target PLMN identity correspond to the permitting identity, a network element or a terminal corresponding to the terminal category or the terminal access number is permitted to perform corresponding access control or a function in a target PLMN corresponding to the target PLMN identity;

if the source PLMN identity and the target PLMN identity correspond to the prohibiting identity, the network element or the terminal corresponding to the terminal category or the terminal access number is prohibited to perform corresponding access control or a function in the target PLMN corresponding to the target PLMN identity.

Eighth access authority control information includes a source PLMN identity, a target PLMN identity and a function identity.

In this scene, yet another implementation of step 103 is:

if a source PLMN identity and a target PLMN identity which correspond to each other exist, a network element or a terminal is permitted to perform corresponding access control or a function corresponding to the function identity in a target PLMN corresponding to the target PLMN identity.

Ninth access authority control information includes a source PLMN identity, a target PLMN identity, a permitting identity and/or a prohibiting identity, and a function identity.

In this scene, yet another implementation of step 103 is:

if a source PLMN identity and a target PLMN identity which correspond to each other exist, a function identity of the source PLMN identity and the target PLMN identity is checked whether corresponding to a permitting identity or a prohibiting identity;

if the function identity corresponds to the permitting identity, a network element or a terminal is permitted to perform corresponding access control or a function corresponding to the function identity in a target PLMN corresponding to the target PLMN identity;

if the function identity corresponds to the prohibiting identity, the network element or the terminal is prohibited to perform the corresponding access control or the function corresponding to the function identity in the target PLMN corresponding to the target PLMN identity.

Tenth access authority control information includes a source PLMN identity, a target PLMN identity, a permitting identity and/or a prohibiting identity, a function identity, and a terminal category or a terminal access number.

In this scene, a tenth implementation of step 103 is:

if a source PLMN identity and a target PLMN identity which correspond to each other exist, a function identity of the source PLMN identity and the target PLMN identity is checked whether corresponding to a permitting identity or a prohibiting identity;

if the function identity corresponds to the permitting identity, a network element or a terminal corresponding to the terminal category or the terminal access number is permitted to perform corresponding access control or a function corresponding to the function identity in a target PLMN corresponding to the target PLMN identity;

if the function identity corresponds to the prohibiting identity, the network element or the terminal corresponding to the terminal category or the terminal access number is prohibited to perform the corresponding access control or the function corresponding to the function identity in the target PLMN corresponding to the target PLMN identity.

It should be noted that, the function corresponding to the function identity includes one or any combination of the following functions: a mobility management function, an MDT continuing function, an MDT terminal selection function, a trace (Trace) function and a data sharing access function. Specifically, the data in the data sharing access function includes one or any combination of the following data: radio link failure (Radio Link Failure, RLF) measurement reporting data, MDT measurement reporting data, and performance and quality of service (Quality of Service, QoS) data.

In addition, the mobility management function is used for indicating whether a terminal is permitted to move from one PLMN to another PLMN and whether the two PLMNs is permitted to exchange data signaling for the mobility management function; the MDT continuing function is used for indicating whether a terminal is permitted to perform an existing MDT function in a PLMN continuously when the terminal is handed over to another PLMN; the MDT selection function is used for indicating whether a terminal of a PLMN is permitted to be selected by another PLMN to perform MDT after moving (being handed over or reselected) to another PLMN; the data sharing access function is used for indicating whether a network element of a PLMN is permitted to access data in a network element of another PLMN.

Eleventh access authority control information includes a PLMN list, wherein the PLMN list lists a group of PLMN identities indicating access permission relationships between every two of a plurality of PLMNs corresponding to the group of PLMN identities respectively or a permitted target PLMN relationship.

Further, if the PLMN list indicates a permitted target PLMN relationship, the source PLMN may be a PLMN to which a terminal belongs, or a EHPLMN, or an PLMN (e.g. a corresponding PLMN ID in Trace Reference) which is an initiator for initiating a terminal task. It should be noted that, the above embodiments are only examples, but not limit the contents in the access authority control information.

The source PLMN in the aforementioned embodiments may mean a PLMN to which a terminal belongs, and the target PLMN may mean a PLMN to which a network currently accessed by the terminal belongs. The PLMN to which the terminal belongs may be an equivalent home PLMN (Equivalent Home PLMN, EHPLMN). The target PLMN may be an equivalent PLMN (Equivalent PLMN, EPLMN).

In another embodiment, the target PLMN further transmits a PLMN identity of a network corresponding to an MDT activation task, for indicating the network transmitting the MDT activation task currently; wherein, a PLMN corresponding to the PLMN identity is an MDT PLMN, and the PLMN identity is obtained from Trace Reference corresponding to the transmitted MDT activation task.

In another embodiment, if an access permission relationship between the PLMN to which the terminal belongs and the PLMN to which the network currently accessed by the terminal belongs exists, one or any combination of the followings is permitted:

a network element of the source PLMN being permitted to select the terminal to perform a minimization of drive-tests function;

a network element of the target PLMN being permitted to select the terminal to perform a minimization of drive-tests function;

a minimization of drive-tests task activated by the terminal in the target PLMN being permitted to be continuously performed in the source PLMN;

a minimization of drive-tests task activated by the terminal in the source PLMN being permitted to be continuously performed in the target PLMN.

In another embodiment, information of the PLMN to which the terminal belongs is obtained from a core network of the PLMN to which the network currently accessed by the terminal belongs.

In another embodiment, the information of the PLMN to which the terminal belongs is transmitted to a access network element in the network currently accessed by the terminal by a core network element of the PLMN to which the network currently accessed by the terminal belongs, for performing corresponding access control or a function by the access network element according to the access permission relationship. In this embodiment, the core network element includes but not limited to, MME, SGSN, GGSN, and MSC. The access network element includes but not limited to, eNB, RNC, and BSC.

The PLMN to which the terminal belongs in the aforementioned embodiments may include a list of a group of PLMNs, and the PLMNs in the list are equivalent for the terminal. The target PLMN may include a list of a group of PLMNs, and the PLMNs in the list are equivalent for the terminal. When the terminal moves from a network element of the source PLMN towards a network element of the target PLMN, the network element of the source PLMN needs to determine whether to continue an MDT function according to an MDT function permission relationship indicated by the PLMN access control authority information.

In addition, the access permission relationship in eleven kinds of access authority control information illustrated above may be a unidirectional relationship or a bidirectional relationship. When the access permission relationship in the access authority control information is the unidirectional relationships, a specific form of the access authority control information may be shown in Table 1:

TABLE 1

| Source PLMN Identity | Target PLMN Identity |
|---|---|
| (Source PLMN) | (Target PLMN) |
| PLMN1 | PLMN2 |
| PLMN2 | PLMN1 |
| PLMN2 | PLMN3 |

As shown in Table 1, the first column in Table 1 denotes source PLMN identities, and the second column denotes target PLMN identities. For example, a source PLMN identity corresponding to a source PLMN corresponding to a terminal is PLMN1, and a target PLMN identity corresponding to a target PLMN is PLMN2; and Table 1 is queried, and an access permission relationship between the source PLMN (the source PLMN identity is PLMN1) and the target PLMN (the target PLMN identity is PLMN2) exists. After the terminal moves from the source PLMN (the source PLMN identity is PLMN1) corresponding to PLMN1 to the target PLMN (the target PLMN identity is PLMN2) corresponding to PLMN2, the terminal is permitted to perform corresponding processing in the target PLMN corresponding to PLMN2. For another example, a source PLMN identity corresponding to a source PLMN corresponding to a terminal is PLMN3, and a target PLMN identity corresponding to a target PLMN is PLMN2; and Table 1 is queried, and an access permission relationship between the source PLMN (the source PLMN identity is PLMN3) and the target PLMN (the target PLMN identity is PLMN2) does not exist. After the terminal moves from the source PLMN corresponding to PLMN3 to the target PLMN corresponding to PLMN2, the terminal is prohibited to perform corresponding processing in the target PLMN corresponding to the PLMN2.

In addition, when the access permission relationship in the access authority control information is the bidirectional relationship, another specific form of the access authority control information may be shown in Table 2:

TABLE 2

| | |
|---|---|
| PLMN1 | PLMN2 |
| PLMN2 | PLMN3 |

As shown in Table 2, the first column in Table 2 may be source PLMN identities or target PLMN identities; and the second column may be target PLMN identities or source PLMN identities. For example, a source PLMN identity corresponding to a source PLMN corresponding to a terminal is PLMN1, and a target PLMN identity corresponding to a target PLMN is PLMN2; and Table 2 is queried, and an access permission relationship between the source PLMN (the source PLMN identity is PLMN1) and the target PLMN (the target PLMN identity is PLMN2) exists. After the terminal moves from the source PLMN corresponding to PLMN1 to the target PLMN corresponding to PLMN2, the terminal is permitted to perform corresponding processing in the target PLMN corresponding to PLMN2. For another example, a source PLMN identity corresponding to a source PLMN corresponding to a terminal is PLMN3, and a target PLMN identity corresponding to a target PLMN is PLMN2; and Table 2 is queried, and a permission relationship between the source PLMN (the source PLMN identity is PLMN3) and the target PLMN (the target PLMN identity is PLMN2) exists. And after the terminal moves from the source PLMN corresponding to PLMN3 to the target PLMN corresponding to PLMN2, the terminal is permitted to perform corresponding processing in the target PLMN corresponding to PLMN2.

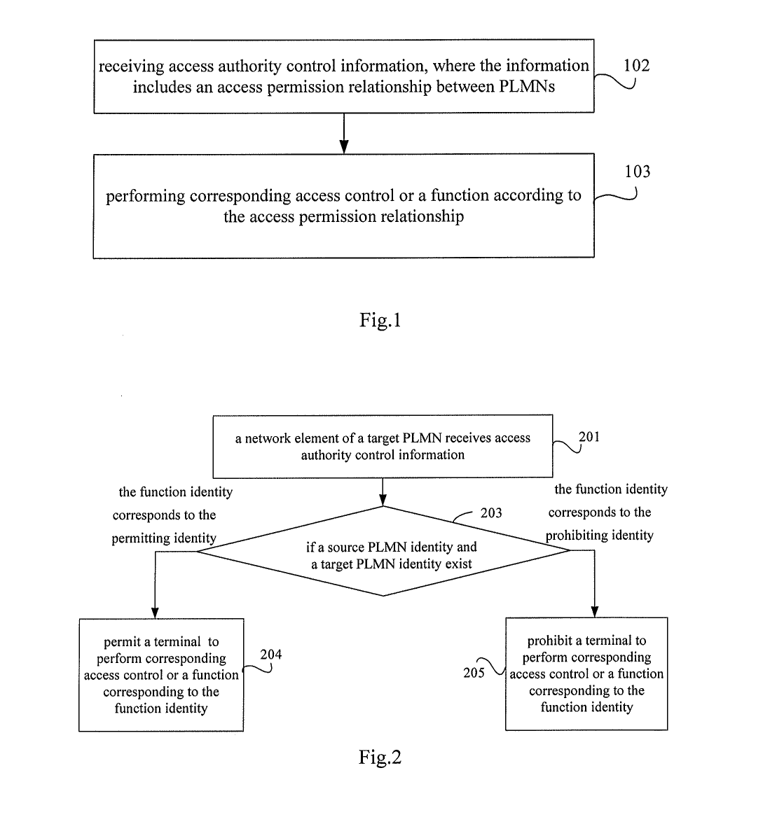

FIG. 2 is a schematic flowchart of a method for processing inter-PLMN access control according to another embodiment of the present invention. In this embodiment, the access authority control information is the tenth access authority control information and the access authority control information is configured in a network element, taken as an example, and a technical method of this embodiment is described in details. The same analogy may be applied to cases, in which the access authority control information is the one except the tenth access authority control information and the access authority control information is configured in the network element, which will not be repeated redundantly. As shown in FIG. 2, a method of this embodiment includes:

Step 201: a network element of a target PLMN receives access authority control information, wherein the access authority control information includes a source PLMN identity, a target PLMN identity, a function identity, a permitting identity and/or a prohibiting identity, and a terminal category or a terminal access number.

Specifically, a function corresponding to the function identity includes one or any combination of the following functions: a mobility management function, an MDT/Trace function and a data sharing access function.

Step 203: if a source PLMN identity and a target PLMN identity which correspond to a terminal exist, the function identity of the source PLMN identity and the target PLMN identity is checked whether corresponding to the permitting identity or the prohibiting identity; if the function identity corresponds to the permitting identity, step 204 is performed; and if the function identity corresponds to the prohibiting identity, step 205 is performed.

Step 204: the network element of the target PLMN permits a terminal corresponding to the terminal category or the terminal access number to perform corresponding access control or a function corresponding to the function identity in the target PLMN corresponding to the target PLMN identity.

Step 205: the network element in the target PLMN prohibits a terminal corresponding to the terminal category or the terminal access number to perform corresponding access control or a function corresponding to the function identity in the target PLMN corresponding to the target PLMN identity.

In this embodiment, multiple operators share a network, which is taken as an example. Specifically, an operator A owns one network, and the PLMN identity used by the network is PLMN1; an operator B owns another network, and the PLMN identity used by the network is PLMN2; and an operator C owns another network, and the PLMN identity used by the network is PLMN3, wherein the operator A, the operator B and the operator C share the network corresponding to the PLMN identity PLMN3.

In addition, the access authority control information may be completed by the operator A, the operator B and the operator C through a consultation. The access authority control information is configured by a NMS of the operator A to a corresponding EMS, and then the access authority control information is set by the EMS to a network element managed by the EMS; the access authority control information is configured by a NMS of the operator B to a corresponding EMS, and then the access authority control information is set by the EMS to a network element managed by the EMS. Because the network corresponding to PLMN3 is a shared network, access authority control information configured by a shared NMS and access authority control information transmitted from the NMSs of the operator A and the operator B are combined by the shared NMS, and finally, access authority control information gotten from the combining process is set by the shared NMS to a shared EMS.

Or, the access authority control information may be completed by the operator A, the operator B and the operator C through a consultation. The access authority control information is configured by a NMS of the operator A to a corresponding EMS, and then the access authority control information is set by the EMS to a network element managed by the EMS; the access authority control information is configured by a NMS of the operator B to a corresponding EMS, and then the access authority control information is set by the EMS to a network element managed by the EMS. Because the network corresponding to PLMN3 is a shared network, access authority control information configured by a shared NMS may be set to a shared EMS.

More specifically, another specific form of the access authority control information may be shown in Table 3:

TABLE 3

| Source | Target | | | | | |
|---|---|---|---|---|---|---|
| PLMN | PLMN | | | | | Terminal |
| Identity | Identity | | | | | Category |
| (Source | (Target | Function 1 | Function 2 | | Function N | (UE |
| PLMN) | PLMN) | (Func1) | (Funcl2) | . . . | (FunclN) | Category) |
| PLMN1 | PLMN2 | Y | N | . . . | N | ID1 |
| PLMN2 | PLMN1 | Y | Y | . . . | Y | ID1 |
| PLMN2 | PLMN3 | N | Y | . . . | Y | ID3 |
| PLMN1 | PLMN3 | Y | Y | . . . | N | IDx |

As shown in Table 3, the table of the access authority control information is a unidirectional table, wherein “Function 1”, “Function 2”, . . . , “Function N” represent function identities respectively; “Y” represents a permitting identity; “N” represents a prohibiting identity. And in this embodiment, the terminal category is taken as an example.

In this embodiment, a terminal (for example, the category of the terminal is ID1) registers in a network corresponding to a PLMN identity PLMN2, the terminal moves from the network corresponding to the PLMN identity PLMN2 to a network corresponding to a PLMN identity PLMN1, and the terminal needs to perform a mobility management function. At this moment, a network element corresponding to the network corresponding to PLMN1 queries its configured Table 3 to check whether a source PLMN identity (PLMN2) and a target PLMN identity (PLMN1) which correspond to the terminal exist. If the source PLMN identity (PLMN2) and the target PLMN identity (PLMN1) exist, a function identity of the mobility management function is further checked whether corresponding to the permitting identity or the prohibiting identity. For example, the “Func1” is the function identity of the mobility management function. As known in Table 3, the “Func1” corresponds to the permitting identity, and a terminal category of the source PLMN identity (PLMN2) and the target PLMN identity (PLMN1) is ID1. So the terminal is permitted to be directly handed over from the source PLMN corresponding to the source PLMN identity PLMN2 to the target PLMN corresponding to the target PLMN identity PLMN1, and perform the same mobility control in the target PLMN as internal mobility management in the source PLMN.

In addition, the terminal is activated in the network corresponding to the PLMN identity PLMN1, and the terminal moves from the network corresponding to the PLMN identity PLMN1 to a network corresponding to the PLMN identity PLMN3 and needs to perform an MDT function. At this moment, a network element corresponding to the network corresponding to PLMN3 queries its configured Table 3 to check whether a source PLMN identity (PLMN1) and a target PLMN identity (PLMN3) which correspond to the terminal exist. If the source PLMN identity (PLMN1) and the target PLMN identity (PLMN3) exist, a function identity of the MDT function is checked whether corresponding to the permitting identity or the prohibiting identity. For example, the “Func2” is the function identity of the MDT function. As known from Table 3, the “Func2” corresponds to the permitting identity. But a terminal category of the source PLMN identity (PLMN1) and the target PLMN identity (PLMN3) is IDx, and the terminal category of the terminal is ID1. Therefore, the network element in the target PLMN corresponding to PLMN3 is prohibited to select the terminal to perform an MDT task, or the terminal is prohibited to perform an MDT task, which is performed in the source PLMN corresponding to the PLMN1 identity, in the target PLMN corresponding to the PLMN3.

It also should be noted that, when the terminal is activated in the network corresponding to the PLMN identity PLMN1, and the terminal moves from the network corresponding to the PLMN identity PLMN1 to the network corresponding to the PLMN identity PLMN3, the terminal needs to perform a mobility management function. At this moment, the network element corresponding to the network corresponding to PLMN3 queries its configured Table 3 to check whether a source PLMN identity (PLMN1) and a target PLMN identity (PLMN3) which correspond to the terminal exist. If the source PLMN identity (PLMN1) and the target PLMN identity (PLMN3) exist, a function identity of the mobility management function is checked whether corresponding to the permitting identity or the prohibiting identity. For example, the “Func1” is the function identity of the mobility management function. As known from Table 3, the “Func1” corresponds to the permitting identity, which indicates that the terminal is permitted to be directly handed over from the source PLMN corresponding to the source PLMN identity PLMN1 to the target PLMN corresponding to the target PLMN identity PLMN3 and to perform the same mobility control in the target PLMN as internal mobility management in the source PLMN.

In this embodiment, the access authority control information is obtained by the network element, wherein the access authority control information includes the source PLMN identity, the target PLMN identity, the function identity, the permitting identity, the prohibiting identity and the terminal category. The access authority control information is queried to check whether a source PLMN identity and a target PLMN identity which correspond to the terminal exist. If the source PLMN identity and the target PLMN identity which correspond to the terminal exist, a function identity of the source PLMN identity and the target PLMN identity is checked whether corresponding to the permitting identity or the prohibiting identity. If the function identity corresponds to the permitting identity, the terminal corresponding to the terminal category is permitted to perform a function corresponding to the function identity in the target PLMN corresponding to the target PLMN identity; and if the function identity corresponds to the prohibiting identity, the terminal corresponding to the terminal category is prohibited to perform a function corresponding to the function identity in the target PLMN corresponding to the target PLMN identity. Thereby, the problem that handover, reselection, continuity of an existing service of the terminal and the like cannot be realized by the terminal in the prior art, is solved, when the terminal accesses another network, namely, when the terminal accesses another PLMN.

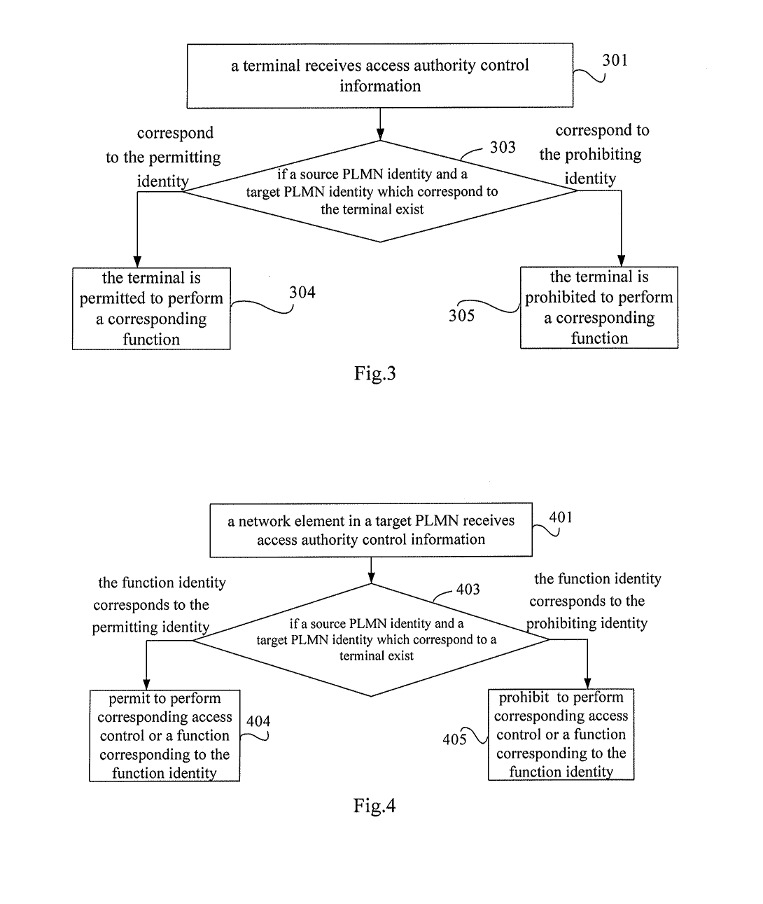

FIG. 3 is a schematic flowchart of a method for processing inter-PLMN access control according to yet another embodiment of the present invention. In this embodiment, the access authority control information is the fifth access authority control information and the access authority control information is configured in a terminal, taken as an example, and a technical method of this embodiment is described in details. The same analogy may be applied to cases, in which the access authority control information is the one except the fifth access authority control information and the access authority control information is configured in the terminal, which will not be repeated redundantly. As shown in FIG. 3, the method of this embodiment includes:

Step 301, a terminal receives access authority control information, wherein the access authority control information includes a source PLMN identity, a target PLMN identity, a permitting identity and/or a prohibiting identity.

In this embodiment, a single operator owns a plurality of networks, which is taken as an example. Specifically, an operator A owns four networks, and PLMN identities used by the four networks are PLMN1, PLMN2, PLMN3 and PLMN4 respectively. In addition, the access authority control information is configured by a NMS of the operator A to a corresponding EMS, and then the access authority is set by the EMS to each network element managed by the EMS.

More specifically, yet another specific form of the access authority control information may be shown in Table 4:

TABLE 4

| | | |
|---|---|---|
| PLMN1 | PLMN2 | Y |
| PLMN2 | PLMN3 | N |
| PLMN1 | PLMN4 | Y |

As shown in Table 4, a permitting relationship of in the access authority control information is a bidirectional permitting relationship; “Y” represents a permitting identity; and “N” represents a prohibiting identity.

In addition, when the terminal registers in a network corresponding to the PLMN identity PLMN2, a network element of the network corresponding to the PLMN identity PLMN2 may configure the access authority control information to the terminal.

Step 303, if a source PLMN identity and a target PLMN identity which correspond to the terminal exist, the source PLMN identity and the target PLMN identity are checked whether corresponding to the permitting identity or the prohibiting identity. If the source PLMN identity and the target PLMN identity correspond to the permitting identity, step 304 is performed; and if the source PLMN identity and the target PLMN identity correspond to the prohibiting identity, step 305 is performed.

Step 304, the terminal is permitted to perform a corresponding function in a target PLMN corresponding to the target PLMN identity.

Step 305, the terminal is prohibited to perform a corresponding function in the target PLMN corresponding to the target PLMN identity.

In this embodiment, the terminal moves from a network corresponding to the PLMN identity PLMN2 to a network corresponding to the PLMN identity PLMN1, and the terminal needs to perform a mobility management function. At this moment, the terminal may query its configured Table 4 to check whether a source PLMN identity (PLMN2) and a target PLMN identity (PLMN1) which correspond to the terminal exist. If the source PLMN identity (PLMN2) and the target PLMN identity (PLMN 1) exist, the source PLMN identity and the target PLMN identity are further checked whether corresponding to the permitting identity or the prohibiting identity. As known from Table 4, the source PLMN identity and the target PLMN identity correspond to the permitting identity, which indicates that the terminal is permitted to be directly handed over from the source PLMN corresponding to the source PLMN identity PLMN2 to the target PLMN corresponding to the target PLMN identity PLMN1 and to perform the same mobility control in the target PLMN as internal mobility management in the source PLMN. In addition, other processing may also be performed, such as handover, being selected by a NMS of the PLMN1 to perform an MDT task, performing an MDT task performed in the network corresponding to PLMN2 continuously in the network corresponding to PLMN1, sharing data (such as data reported by the terminal) of the network corresponding to PLMN2 with the network corresponding to PLMN1, and the like.

The terminal moves from the network corresponding to the PLMN identity PLMN2 to the network corresponding to the PLMN identity PLMN1, and the terminal needs to perform a measurement task. At this moment, the terminal queries its configured Table 4 to check whether a source PLMN identity (PLMN2) and a target PLMN identity (PLMN1) which correspond to the terminal exist. If the source PLMN identity (PLMN2) and the target PLMN identity (PLMN1) exist, the source PLMN identity and the target PLMN identity are checked whether corresponding to the permitting identity or the prohibiting identity. As known from Table 4, the source PLMN identity and the target PLMN identity correspond to the permitting identity, which indicates that the terminal may perform the measurement task in the target PLMN corresponding to PLMN1.

In this embodiment, the access authority control information is obtained by the terminal; wherein the access authority control information includes the source PLMN identity, the target PLMN identity, the permitting identity and/or the prohibiting identity. The terminal queries the access authority control information, and checks whether the source PLMN identity and the target PLMN identity which correspond to the terminal exist. If the source PLMN identity and the target PLMN identity which correspond to the terminal exist, the source PLMN identity and the target PLMN identity are checked whether corresponding to the permitting identity or the prohibiting identity. If the source PLMN identity and the target PLMN identity correspond to the permitting identity, the terminal is permitted to perform a corresponding function in the target PLMN corresponding to the target PLMN identity; and if the source PLMN identity and the target PLMN identity correspond to the prohibiting identity, the terminal is prohibited to perform a corresponding function in the target PLMN corresponding to the target PLMN identity. Thereby, the problem that handover, reselection, continuity of an existing service of the terminal and the like cannot be realized by the terminal in the prior art, is solved, when the terminal accesses another network, namely, when the terminal accesses another PLMN.

FIG. 4 is a schematic flowchart of a method for processing inter-PLMN access control according to another embodiment of the present invention. In this embodiment, the access authority control information is the ninth access authority control information and is configured in a network element, taken as an example, and a technical method of this embodiment is described in details. The same analogy may be applied to cases, in which the access authority control information is the one except the ninth access authority control information and the access authority control information is configured in the network element, which will not be repeated redundantly. As shown in FIG. 4, the method of this embodiment includes:

Step 401, a network element in a target PLMN receives access authority control information, wherein the access authority control information includes a source PLMN identity, a target PLMN identity, a function identity, a permitting identity and/or a prohibiting identity.

Specifically, a function corresponding to the function identity includes one or any combination of the following functions: a mobility management function, an MDT/Trace function, and a data sharing access function.

Step 403, if a source PLMN identity and a target PLMN identity which correspond to a terminal exist, a function identity of the source PLMN identity and the target PLMN identity is checked whether corresponding to the permitting identity or the prohibiting identity; if the function identity corresponds to the permitting identity, step 404 is performed; and if the function identity corresponds to the prohibiting identity, step 405 is performed.

Step 404, the network element in the target PLMN permits a network element in the source PLMN to perform corresponding access control or a function corresponding to the function identity in the target PLMN corresponding to the target PLMN identity.

Step 405, the network element in the target PLMN prohibits the network element in the source PLMN to perform corresponding access control or a function corresponding to the function identity in the target PLMN corresponding to the target PLMN identity.

In this embodiment, multiple operators share a network, which is taken as an example. Specifically, an operator A owns a network, and the PLMN identity used by the network is PLMN1; an operator B owns another network, and the PLMN identity used by the network is PLMN2; and an operator C owns another network, and the PLMN identity used by the network is PLMN3, wherein the operator A, the operator B and the operator C share the network corresponding to the PLMN identity PLMN3.

In addition, the access authority control information may be completed by the operator A, the operator B and the operator C through a consultation. The access authority control information is configured by a NMS of the operator A to a corresponding EMS, and then the access authority control information is set by the EMS to a network element managed by the EMS; the access authority control information is configured by a NMS of the operator B to a corresponding EMS, and then the access authority control information is set by the EMS to a network element managed by the EMS. Because the network corresponding to PLMN3 is a shared network, access authority control information configured by a shared NMS and access authority control information transmitted from the NMSs of the operator A and the operator B are combined by the shared NMS, and finally, access authority control information gotten from the combing process is set by the shared NMS to a shared EMS.

Or, the access authority control information may be completed by the operator A, the operator B and the operator C through a consultation. The access authority control information is configured by a NMS of the operator A to a corresponding EMS, and then the access authority control information is set by the EMS to a network element managed by the EMS; the access authority control information is configured by a NMS of the operator B to a corresponding EMS. Because the network corresponding to PLMN3 is a shared network, access authority control information configured by a shared NMS may be set to a shared EMS.

More specifically, another specific form of the access authority control information may be shown in Table 5:

TABLE 5

| Source | Target | | | | |
|---|---|---|---|---|---|
| PLMN | PLMN | | | | |
| Identity | Identity | | | | |
| (Source | (Target | Function 1 | Function 2 | | Function N |
| PLMN) | PLMN) | (Func1) | (Funcl2) | . . . | (FunclN) |
| PLMN1 | PLMN2 | Y | N | . . . | N |
| PLMN2 | PLMN1 | Y | Y | . . . | Y |
| PLMN2 | PLMN3 | N | Y | . . . | Y |
| PLMN1 | PLMN3 | Y | Y | . . . | N |

As shown in Table 5, the table of the access authority control information is a unidirectional table, wherein “Function 1”, “Function 2”, . . . , “Function N” represent function identities respectively; “Y” represents a permitting identity; and “N” represents a prohibiting identity.

In this embodiment, the terminal registers in a network corresponding to the PLMN identity PLMN2, the terminal moves from the network corresponding to the PLMN identity PLMN2 to a network corresponding to the PLMN identity PLMN1, and a network element in the network corresponding to the PLMN identity PLMN2 needs to realize data sharing access with the network element in the network corresponding to the PLMN identity PLMN1. At this moment, the network element corresponding to the network corresponding to PLMN1 queries its configured Table 5 to check whether a source PLMN identity (PLMN2) and a target PLMN identity (PLMN1) which correspond to the network element in the network corresponding to the PLMN identity PLMN2 exist. If the source PLMN identity (PLMN2) and the target PLMN identity (PLMN1) exist, a function identity of the data sharing access function is checked whether corresponding to the permitting identity or the prohibiting identity. For example, the “Func1” is the function identity of the data sharing access function. As known from Table 5, the “Func1” corresponds to the permitting identity, which indicates that the network element in the network corresponding to the PLMN identity PLMN2 is permitted to access existing data in the network element in the network corresponding to the PLMN identity PLMN1.

In this embodiment, the access authority control information is obtained by the network element in the target PLMN, wherein the access authority control information includes the source PLMN identity, the target PLMN identity, the function identity, the permitting identity and the prohibiting identity. The access authority control information is queried to check whether the source PLMN identity and the target PLMN identity which correspond to the network element in the source PLMN exist. If the source PLMN identity and the target PLMN identity which correspond to the network element in the source PLMN exist, a function identity of the source PLMN identity and the target PLMN identity is checked whether corresponding to the permitting identity or the prohibiting identity. If the function identity corresponds to the permitting identity, the network element in the source PLMN is permitted to perform a function corresponding to the function identity in the target PLMN corresponding to the target PLMN identity; and if the function identity corresponds to the prohibiting identity, the network element in the source PLMN is prohibited to perform the function corresponding to the function identity in the target PLMN corresponding to the target PLMN identity. Thereby, the problem that handover, reselection, continuity of an existing service of the terminal and the like cannot be realized by the terminal in the prior art, is solved, when the terminal accesses another network, namely, when the terminal accesses another PLMN.

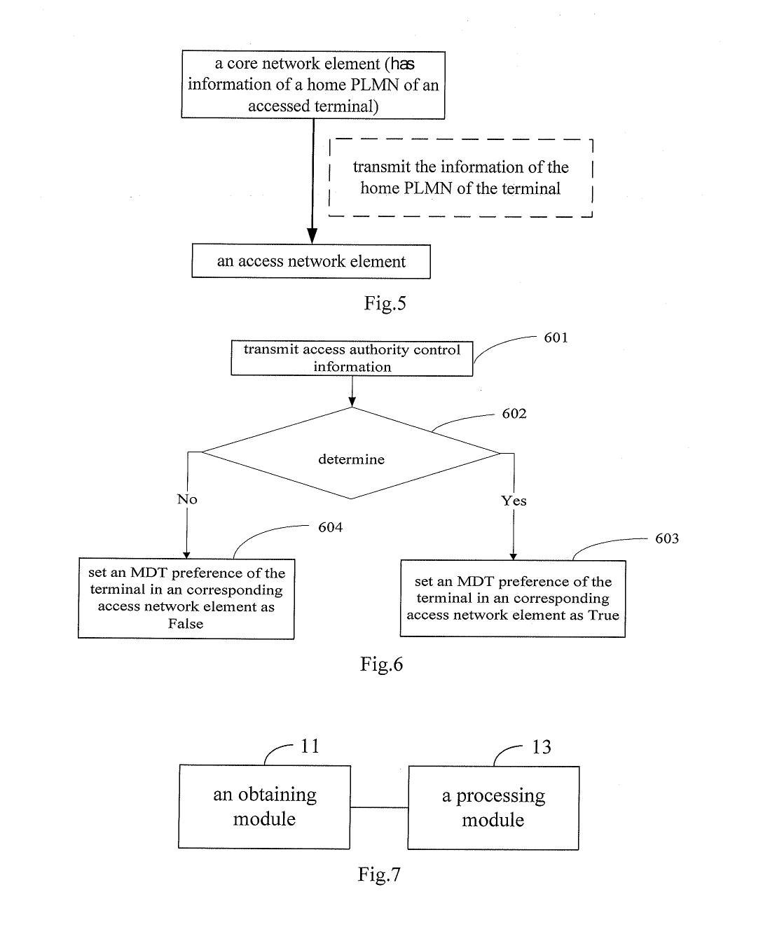

FIG. 5 is a schematic flowchart of a method for processing inter-PLMN access control according to yet another embodiment of the present invention. In this embodiment, when a terminal accesses a certain network, an access network element of the network does not know information of a PLMN to which the terminal belongs, but a core network element corresponding to the access network element knows the information. The information may be obtained from the core network element when the terminal accesses the network.

The core network element takes information of a home PLMN of the terminal as information of the source PLMN. The access authority control information is the ninth access authority control information and is configured in the network element, taken as an example, and a technical method and the specific contents for implementing the embodiment may be referred to descriptions of the aforementioned embodiments, and will not be repeated redundantly.

When the access network element also needs to perform the same access control as the core network element, the core network element corresponding to the access network element is required to transmit the information of the home PLMN of the terminal to the access network element. The core network element may be a core network element of the source PLMN or a core network element of the target PLMN. Herein the target PLMN is a PLMN corresponding to a network to be accessed by the terminal.

After the access network element receives the information, the information of the home PLMN of the terminal is taken as the information of the source PLMN. The access authority control information is the ninth access authority control information and is configured in the network element, taken as an example, and a technical method and the specific contents for implementing the embodiment may be referred to descriptions of the aforementioned embodiments, and will not be repeated redundantly.

The transmitted home PLMN may be a home PLMN corresponding to the terminal or an EHPLMN list.

The same analogy may be applied to cases in which the access authority control information is the one except the ninth access authority control information and the access authority control information is configured in the network element, which will not be repeated redundantly.

FIG. 6 is a schematic flowchart of a method for processing inter-PLMN access control according to yet another embodiment of the present invention. The method of this embodiment includes: access authority control information, where the information includes an access permission relationship between PLMNs.

Step 601, a network manager transmits access authority control information to a core network element of a PLMN, where the information includes an access permission relationship between PLMNs. The specific form of the information may be a PLMN access control information list. The list may include one or more PLMN IDs. The core network element of the PLMN has PLMN information to which a terminal belongs. The core network element of the PLMN corresponds to a PLMN to be accessed by the terminal, or is referred to as a target PLMN.

Step 602, the core network element of the PLMN determines whether the PLMN to which the terminal belongs corresponds to a certain PLMN in the PLMN access control information list;

Step 603, if the PLMN to which the terminal belongs corresponds to a certain PLMN in the PLMN access control information list, the target PLMN permits an accessed terminal to perform a minimization of drive-tests function, or an existing minimization of drive-tests task may be continued in the target PLMN, which is realized through setting a minimization of drive-tests preference of the terminal stored in an access network element as true by the core network.

Step 604, if the PLMN to which the terminal belongs does not correspond to a certain PLMN in the PLMN access control information list, the target PLMN prohibits an accessed terminal to perform a minimization of drive-tests function, or an existing minimization of drive-tests task may not be continued in the target PLMN, which is realized through setting an MDT preference of the terminal stored in an access the network element as false.

FIG. 7 is a schematic structural diagram of an apparatus for processing inter-PLMN access control according to an embodiment of the present invention. The processing apparatus of this embodiment may be a network element or a terminal. The network element may be a network element managed by an EMS. The network element may be an evolved node B (evolved Node B, eNB) or a radio network controller (Radio Network Controller, RNC) of an access network; or the network element may be a mobility management entity (Mobility Management Entity, MME) or a general packet radio service (General Packet Radio Service, GPRS) serving GPRS support node (Servicing GPRS Support Node, SGSN) of a core network. FIG. 7 merely illustrates part of modules or functional modules of the processing apparatus. General components such as a processor, a memory, an input and an output and the like for the processing apparatus are not shown in order to simplify expression. Each module shown in FIG. 7 may be a specific hardware (such as a chip or a chipset) or a software functional module run by a processor.

Specifically, the processing apparatus includes an obtaining module 11 and a processing module 13, wherein,

the obtaining module 11 is configured to receive access authority control information, where the information includes an access permission relationship between PLMNs.

For example, the information may include an access permission relationship between a source PLMN and a target PLMN. The source PLMN and the target PLMN may correspond to a network element or a terminal.

The information may also include a PLMN list, and the list lists a group of PLMN identities, indicating:

access permission relationships between every two of a plurality of PLMNs corresponding to the group of PLMN identities respectively, wherein any two PLMNs include a source PLMN and a target PLMN; or

PLMNs corresponding to the group of PLMN identities respectively are PLMNs permitting a network element or a terminal to access.

Herein the access permission relationship may specifically be:

whether a network element of the source PLMN is permitted to select a terminal to perform a minimization of drive-tests function after the terminal belonging to the target PLMN moves to the source PLMN; and/or

whether a minimization of drive-tests task activated by a terminal in the target PLMN is permitted to be continuously performed in the source PLMN after the terminal belonging to the target PLMN moves to the source PLMN.

The processing module 13, coupled with the obtaining module 11 is configured to perform corresponding access control or a function according to the access permission relationship.

The apparatus of this embodiment is suitable to perform the technical solutions of the embodiments of the preceding respective method, and the principle, process, method and change of its specific implementation will not repeated herein.

Persons of ordinary skill in the art may understand that, all or a part of the steps of the foregoing method embodiments may be implemented by a program instructing relevant hardware, for example, may be implemented by running program instructions by a processor. The program may be stored in a computer readable storage medium. When the program runs, the steps of the foregoing method embodiments are performed. The storage medium includes: any medium that can store program codes, such as an ROM, an RAM, a magnetic disk, or an optical disc. The above-mentioned program may be stored in a computer readable storage medium. The procedures of the embodiments of the respective methods mentioned above may be included when the program is executed; and the above-mentioned storage medium includes various kinds of medium that may store program codes, such as a ROM, a RAM, a magnetic disk, an optical disk, or the like.

The embodiments of the apparatus described above are only exemplary, wherein a unit illustrated as a separate component may be physically separated or not, and a component displayed as the unit may be a physical unit or not, that is, may be located in one position, or may be distributed in at least two network units. The objectives of the solutions of the embodiments may be realized by selecting a part or all of the modules according to the actual requirement, which may be understood and implemented by persons of ordinary skill in the art without inventive efforts.

### Other Embodiments

Embodiment 1: an apparatus includes a storage component and a processor, where the processor is configured to read and run program instructions stored in the storage component, so that the following steps of a method are performed:

receiving access authority control information, where the information includes an access permission relationship between PLMNs;

performing corresponding access control or a function according to the access permission relationship.

Embodiment 2: according to embodiment 1, the access permission relationship between the PLMNs is an access permission relationship between a source PLMN and a target PLMN.

Embodiment 3: according to embodiment 1, the access authority control information includes a PLMN list, where the list lists a group of PLMN identities, indicating:

access permission relationships between every two of a plurality of PLMNs corresponding to the group of PLMN identities respectively, wherein any two PLMNs include a source PLMN and a target PLMN; or

PLMNs corresponding to the group of PLMN identities respectively are PLMNs permitting to be accessed.

Embodiment 4: according to embodiment 2, the access permission relationship is specifically:

whether a network element of the source PLMN is permitted to select a terminal to perform a minimization of drive-tests function after the terminal belonging to the target PLMN moves to the source PLMN; and/or

whether a minimization of drive-tests task activated by a terminal in the target PLMN is permitted to be performed continuously in the source PLMN after the terminal belonging to the target PLMN moves to the source PLMN.

Embodiment 5: according to embodiment 2 or 3, the access permission relationship includes one or any combination of the following access permission relationships:

whether a network element belonging to the source PLMN is permitted to access existing data in a network element belonging to the target PLMN;

whether a network element belonging to the target PLMN is permitted to access existing data in a network element belonging to the source PLMN;

whether a network element belonging to the source PLMN is permitted to transmit mobility control data to a network element belonging to the target PLMN for inter-PLMN movement of a terminal;

whether a network element belonging to the target PLMN is permitted to transmit mobility control data to a network element belonging to the source PLMN for inter-PLMN movement of a terminal;

whether a terminal belonging to the source PLMN is permitted to move to the target PLMN;

whether a terminal belonging to the target PLMN is permitted to move to the source PLMN;

whether an existing function is permitted to be continuously performed after a terminal belonging to the source PLMN moves to the target PLMN;

whether an existing function is permitted to be continuously performed after a terminal belonging to the target PLMN moves to the source PLMN;

whether the target PLMN is permitted to select a specified function or application to perform after a terminal belonging to the source PLMN moves to the target PLMN;

whether the source PLMN is permitted to select a specified function or application to perform after a terminal belonging to the target PLMN moves to the source PLMN.

Embodiment 6: according to embodiment 5, whether the target PLMN is permitted to select a specified function or application to perform after a terminal belonging to the source PLMN moves to the target PLMN, is specifically:

whether a network element of the target PLMN is permitted to select the terminal to perform a minimization of drive-tests function after the terminal belonging to the source PLMN moves to the target PLMN; and/or

whether a minimization of drive-tests task activated by the terminal in the source PLMN, is permitted to be performed continuously in the target PLMN after the terminal belonging to the source PLMN moves to the target PLMN.

Embodiment 7: according to embodiment 5, whether the source PLMN is permitted to select a specified function or application to perform after a terminal belonging to the target PLMN moves to the source PLMN, is specifically:

whether a network element of the source PLMN is permitted to select the terminal to perform a minimization of drive-tests function after the terminal belonging to the target PLMN moves to the source PLMN; and/or

whether a minimization of drive-tests task activated by the terminal in the target PLMN is permitted to be performed continuously in the source PLMN after the terminal belonging to the target PLMN moves to the source PLMN.

Embodiment 8: according to embodiment 6 or 7, the network element is a core network element and/or an access network element.

Embodiment 9: according to embodiment 2 or 3, the access permission relationship includes one or any combination of the following access permission relationships:

whether the target PLMN is permitted to select a specified function or application to perform when a terminal belonging to the source PLMN moves towards the target PLMN;

whether the source PLMN is permitted to select a specified function or application to perform when a terminal belonging to the target PLMN moves towards the source PLMN.

Embodiment 10: according to embodiment 9, whether the target PLMN is permitted to select a specified function or application to perform when a terminal belonging to the source PLMN moves towards the target PLMN, is specifically:

whether a minimization of drive-tests task activated by a terminal in the source PLMN is permitted to be performed continuously in the target PLMN when the terminal belonging to the source PLMN moves towards the target PLMN.

Embodiment 11: according to embodiment 10, whether the minimization of drive-tests task activated by the terminal in the source PLMN is permitted to be performed continuously in the target PLMN, is determined by a network element or a cell of the source PLMN according to the access permission relationship.

Embodiment 12: according to embodiment 11, if the minimization of drive-tests task activated by the terminal in the source PLMN is not permitted to be continuously performed in the target PLMN, the minimization of drive-tests task is terminated by the network element or the cell of the source PLMN.

Embodiment 13: according to embodiment 9, whether the source PLMN is permitted to select a specified function or application to perform when a terminal belonging to the target PLMN moves towards the source PLMN, is specifically:

whether a minimization of drive-tests task, activated by a terminal in the target PLMN is permitted to be performed continuously in the source PLMN when the terminal belonging to the target PLMN moves towards the source PLMN.

Embodiment 14: according to embodiment 13, whether the minimization of drive-tests task activated by the terminal in the target PLMN is permitted to be performed continuously in the source PLMN, is determined by a network element or a cell of the target PLMN according to the access permission relationship.

Embodiment 15: according to embodiment 14, if the minimization of drive-tests task activated by the terminal in the target PLMN is not permitted to be continuously performed in the source PLMN, the minimization of drive-tests task is terminated by the network element or the cell of the target PLMN.

Embodiment 16: according to embodiment 9, whether the target PLMN is permitted to select a specified function or application to perform when a terminal moves from the source PLMN towards the target PLMN, is specifically:

whether the target PLMN is permitted to select the terminal to perform a minimization of drive-tests task or to continue a minimization of drive-tests task activated in the source PLMN is controlled through setting, by a core network element of the source PLMN or the target PLMN, a minimization of drive-tests preference corresponding to the terminal to an access network element of the target PLMN according to the access authority control information.

Embodiment 17: according to any one of the aforementioned embodiments, the access authority control information includes one or any combination of the followings:

a table, including a pair of PLMN identities, wherein the pair of PLMN identities includes a source PLMN identity and a target PLMN identity which correspond to each other;

a table, including a pair of PLMN identities and an MDT function identity, wherein the pair of PLMN identities includes a source PLMN identity and a target PLMN identity which correspond to each other;

a table, including a pair of PLMN identities, an MDT function identity, a permitting identity and/or a prohibiting identity, wherein the pair of PLMN identities includes a source PLMN identity and a target PLMN identity which correspond to each other;

a source PLMN identity and a target PLMN identity;

a source PLMN identity, a target PLMN identity, a permitting identity and/or a prohibiting identity;

a source PLMN identity, a target PLMN identity, a terminal category or a terminal access number;

a source PLMN identity, a target PLMN identity, a permitting identity and/or a prohibiting identity, a terminal category or a terminal access number;

a source PLMN identity, a target PLMN identity, and a function identity; a source PLMN identity, a target PLMN identity, a permitting identity and/or a prohibiting identity, and a function identity;

a source PLMN identity, a target PLMN identity, a permitting identity and/or a prohibiting identity, a function identity, and a terminal category or a terminal access number;

a PLMN list, where the list lists a group of PLMN identities, which indicates access permission relationships between every two of a plurality of PLMNs corresponding to the group of PLMN identities respectively.

Embodiment 18: according to embodiment 17, a function corresponding to the function identity includes one or any combination of the following functions: a mobility management function, an MDT continuing function, an MDT terminal selection function, a trace function and a data sharing access function.

Embodiment 19: according to embodiment 18, data in the data sharing access function includes one or any combination of the following data: radio link failure measurement reporting data, MDT measurement reporting data, and performance and quality of service data.

Embodiment 20: according to any one of aforementioned embodiments, the source PLMN means a PLMN to which a terminal belongs, and the target PLMN means a PLMN to which a network currently accessed by the terminal belongs.

Embodiment 21: according to embodiment 20, if an access permission relationship between the PLMN to which the terminal belongs and the PLMN to which the network currently accessed by the terminal belongs exists, one or any combination of the followings is permitted:

a network element of the source PLMN being permitted to select the terminal to perform a minimization of drive-tests function;

a network element of the target PLMN being permitted to select the terminal to perform a minimization of drive-tests function;

a minimization of drive-tests task activated by the terminal in the target PLMN being permitted to be performed continuously in the source PLMN;

a minimization of drive-tests task activated by the terminal in the source PLMN being permitted to be performed continuously in the target PLMN.

Embodiment 22: according to embodiment 20, information of the PLMN to which the terminal belongs is obtained from a core network of the PLMN to which the network currently accessed by the terminal belongs.

Embodiment 23: according to embodiment 22, the information of the PLMN to which the terminal belongs is transmitted, by a core network element of the PLMN to which the network currently accessed by the terminal belongs, to an access network element of the network currently accessed by the terminal, for performing corresponding access control or a function by the access network element according to the access permission relationship.

Embodiment 24: according to embodiment 23, the core network element is one of the followings: MME, SGSN, GGSN, and MSC.

Embodiment 25: according to embodiment 23, the access network element is one of the followings: eNB, RNC, and BSC.

Embodiment 26: according to embodiment 20, the PLMN to which the terminal belongs includes a list of a group of PLMNs, where the PLMNs in the list are equivalent for the terminal.

Embodiment 27: according to embodiment 20, the PLMN to which the terminal belongs is an EHPLMN.

Embodiment 28: according to embodiment 20, the target PLMN includes a list of a group of PLMNs, where the PLMNs in the list are equivalent for the terminal.

Embodiment 29: according to embodiment 20, the target PLMN is an EPLMN.

Embodiment 30: according to embodiment 20, a PLMN identity of a network corresponding to an MDT activation task is transmitted by the target PLMN, for indicating the network transmitting the MDT activation task currently; wherein, a PLMN corresponding to the PLMN identity is an MDT PLMN, and the PLMN identity is obtained from Trace Reference corresponding to the transmitted MDT activation task.

Embodiment 31: according to any one of embodiments 20-30, a network element of the source PLMN needs to determine whether to continue an MDT function according to an MDT function permission relationship indicated by the PLMN access control authority information when the terminal moves from the network element of the source PLMN towards a network element of the target PLMN.

Embodiment 32: according to any one of embodiments 1-3, the performing corresponding access control or a function according to the access permission relationship means: all PLMNs that a terminal can mobility access are permitted to perform an MDT continuing function, an MDT terminal selection function, a trace function, and a data sharing access function.

Embodiment 33: according to embodiments 1-2, the access permission relationship is a unidirectional relationship or a bidirectional relationship.

Embodiment 34: according to any one of embodiments 1-3, the access authority control information is configured by a network management system to a network element management system corresponding to the network management system.

Embodiment 35: according to any one of embodiments 1-3, the access authority control information is set by a network element management system to a network element managed by the network element management system, wherein the network element is one or any combination of the followings: an evolved Node B, a radio network controller, a mobility management entity and a serving GPRS support node.

Embodiment 36: according to embodiment 35, the access authority control information is further configured by the network element managed by the network element management system to the terminal.

Embodiment 37: according to any one of embodiments 1-7, the access authority control information may be transmitted to a terminal, so that the terminal determines whether to perform a corresponding function or information access according to the control information.

Embodiment 38: according to any one of aforementioned embodiments, the access control or the function includes one or any combination of the followings: handover and reselection of a inter-PLMN terminal, continuous processing of an existing service of the terminal, recording cell information of a PLMN that the terminal accesses measured by the terminal, and a minimization drive-tests function.

Embodiment 39: according to embodiment 2, the source PLMN corresponds to a network registered by a terminal, or the source PLMN corresponds to a network which a data access party is in, or the source PLMN is a network which a function initiator or initializer is in.

Finally, it should be noted that the foregoing embodiments are merely intended for describing the technical solutions of the present invention other than limiting the present invention. Although the present invention is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present invention.

What is claimed is:

1. A method for processing inter-Public Land Mobile Network (inter-PLMN) access control, comprising:
receiving access authority control information, wherein the access authority control information comprises an access permission relationship between PLMNs;
performing access control or a function according to the access permission relationship.

2. The method of claim 1, wherein the access permission relationship between PLMNs is an access permission relationship between a source PLMN and a target PLMN.

3. The method of claim 1, wherein the access authority control information comprises a PLMN list, which lists a group of PLMN identities, indicating:
access permission relationships between every two of a plurality of PLMNs corresponding to the group of PLMN identities, wherein any two PLMNs comprise a source PLMN and a target PLMN; or
PLMNs corresponding to the group of PLMN identities are PLMNs permitting to be accessed.

4. The method of claim 3, wherein the access permission relationship comprises at least one of the following access permission relationships:
whether a network element belonging to the source PLMN is permitted to access existing data in a network element belonging to the target PLMN;
whether a network element belonging to the target PLMN is permitted to access existing data in a network element belonging to the source PLMN;
whether a network element belonging to the source PLMN is permitted to transmit mobility control data to a network element belonging to the target PLMN for an inter-PLMN movement of a terminal;
whether a network element belonging to the target PLMN is permitted to transmit mobility control data to a network element belonging to the source PLMN for an inter-PLMN movement of a terminal;
whether a terminal belonging to the source PLMN is permitted to move to the target PLMN;
whether a terminal belonging to the target PLMN is permitted to move to the source PLMN;
whether an existing function is permitted to be performed continuously after a terminal belonging to the source PLMN moves to the target PLMN;
whether an existing function is permitted to be performed continuously after a terminal belonging to the target PLMN moves to the source PLMN;
whether the target PLMN is permitted to select a specified function or application to perform after a terminal belonging to the source PLMN moves to the target PLMN;
whether the source PLMN is permitted to select a specified function or application to perform after a terminal belonging to the target PLMN moves to the source PLMN;
whether the target PLMN is permitted to select a specified function or application to perform when a terminal belonging to the source PLMN moves towards the target PLMN;
whether the source PLMN is permitted to select a specified function or application to perform when a terminal belonging to the target PLMN moves towards the source PLMN.

5. The method of claim 4, wherein whether the target PLMN is permitted to select a specified function or application to perform after a terminal belonging to the source PLMN moves to the target PLMN, comprises at least one of:
whether a network element of the target PLMN is permitted to select the terminal to perform a minimization of drive-tests function after the terminal belonging to the source PLMN moves to the target PLMN; and whether a minimization of drive-tests task activated by the terminal in the source PLMN, is permitted to be performed continuously in the target PLMN after the terminal belonging to the source PLMN moves to the target PLMN.

6. The method of claim 4, wherein whether the target PLMN is permitted to select a specified function or application to perform when a terminal belonging to the source PLMN moves towards the target PLMN, comprises:
whether a minimization of drive-tests task activated by the terminal in the source PLMN is permitted to be performed continuously in the target PLMN when the terminal belonging to the source PLMN moves towards the target PLMN.

7. The method of claim 4, wherein whether the target PLMN is permitted to select a specified function or application to perform when a terminal moves from the source PLMN towards the target PLMN, comprises:
whether the target PLMN is permitted to select the terminal to perform a minimization of drive-tests task or to continue a minimization of drive-tests task activated in the source PLMN is controlled through setting, by a core network element of the source PLMN or the target PLMN, a minimization of drive-tests preference corresponding to the terminal to an access network element of the target PLMN according to the access authority control information.

8. The method of claim 1, wherein the access authority control information comprises at least one of the followings:
a table, comprising a pair of PLMN identities, wherein the pair of PLMN identities comprises a source PLMN identity and a target PLMN identity, which correspond to each other;
a table, comprising a pair of PLMN identities and an MDT function identity, wherein the pair of PLMN identities comprises a source PLMN identity and a target PLMN identity, which correspond to each other;
a table, comprising a pair of PLMN identities, an MDT function identity, a permitting identity and/or a prohibiting identity, wherein the pair of PLMN identities comprises a source PLMN identity and a target PLMN identity, which correspond to each other;
a source PLMN identity and a target PLMN identity;
at least one of a source PLMN identity, a target PLMN identity, a permitting identity and a prohibiting identity;
a source PLMN identity, a target PLMN identity, a terminal category or a terminal access number;
at least one of a source PLMN identity, a target PLMN identity, a permitting identity and a prohibiting identity, a terminal category or a terminal access number;
a source PLMN identity, a target PLMN identity, and a function identity;
a source PLMN identity, a target PLMN identity, a permitting identity and/or a prohibiting identity, and a function identity;
a source PLMN identity, a target PLMN identity, a permitting identity and/or a prohibiting identity, a function identity, and a terminal category or a terminal access number;
a PLMN list, which lists a group of PLMN identities, indicating access permission relationships between every two of a plurality of PLMNs corresponding to the group of PLMN identities respectively.

9. The method of claim 8, wherein a function corresponding to the function identity comprises at least one of the following functions: a mobility management function, an MDT continuing function, an MDT terminal selection function, a trace function and a data sharing access function.

10. The method of claim 9, wherein data in the data sharing access function comprises at least one of the following data: radio link failure measurement reporting data, MDT measurement reporting data, and performance and quality of service data.

11. The method of claim 1, wherein the PLMN includes a source PLMN and a target PLMN, and the source PLMN means a PLMN to which a terminal belongs, and the target PLMN means a PLMN to which a network currently accessed by the terminal belongs.

12. The method of claim 11, wherein a PLMN identity of a network corresponding to an MDT activation task is transmitted by the target PLMN, for indicating the network transmitting the MDT activation task currently; wherein, a PLMN corresponding to the PLMN identity is an MDT PLMN, and the PLMN identity is obtained from Trace Reference corresponding to the transmitted MDT activation task.

13. The method of claim 11, wherein a network element of the source PLMN needs to determine whether to continue an MDT function according to an MDT function permission relationship indicated by the PLMN access control authority information when the terminal moves from the network element of the source PLMN towards a network element of the target PLMN.

14. The method of claim 1, wherein the performing corresponding access control or a function according to the access permission relationship means:
all PLMNs that a terminal can mobility access are permitted to perform an MDT continuing function, an MDT terminal selection function, a trace function, and a data sharing access function.

15. The method of claim 1, wherein the access authority control information is transmitted to a terminal, so that the terminal determines whether to perform a corresponding function or information access according to the control information.

16. The method of claim 1, wherein the access control or the function comprises at least one of the followings: handover and reselection of a inter-PLMN terminal, continuous processing of an existing service of the terminal, recording cell information of a PLMN that the terminal accesses measured by the terminal, and a minimization drive-tests function.

17. An apparatus for processing access control, comprising:
an obtaining module, configured to receive access authority control information, wherein the access authority control information comprises a access permission relationship between PLMNs;
a processing module, coupled with the obtaining module, configured to perform corresponding access control or a function according to the permission relationship.

18. The apparatus for processing access control of claim 17, wherein the apparatus for processing access control is a network element managed by a network element management system, wherein the network element is one or any combination of the followings: an evolved node B, a radio network controller, a mobility management entity and a serving GPRS support node.

19. The apparatus for processing access control of claim 17, wherein the apparatus for processing access control of is a terminal.

20. An apparatus, comprising: a storage component and a processor, wherein the processor is configured to read and run program instructions stored in the storage component, so that the following steps of a method are performed:
receiving access authority control information, wherein the access authority control information comprises an access permission relationship between PLMNs;
performing corresponding access control or a function according to the access permission relationship.
